(19) United States
(12) Patent Application Publication
(10) Pub. No.: US 2008/0209355 A1
(43) Pub. Date: Aug. 28, 2008

(54) APPARATUS AND METHOD FOR IMPLEMENTING USER INTERFACE USED FOR GROUP COMMUNICATION

(75) Inventors: Ju-Youn Lee, Seongnam-si (KR); Young-ho Rhee, Seoul (KR); Ja-Yeon Lee, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/842,537

(22) Filed: Aug. 21, 2007

(30) Foreign Application Priority Data
Feb. 26, 2007 (KR) 2007-19223

(51) Int. Cl. G06F 3/048

(52) U.S. Cl. 715/767; 715/764

(57) ABSTRACT

An apparatus and method for implementing a user interface used for a group communication. The apparatus includes a constructing unit to construct a plurality of user interfaces (UIs) in a predetermined format and an output unit to display in a first image the constructed UIs and objects selected by the UIs. The UIs include a first U to select content, a second UI to select a function corresponding to the content, and a third UI to select persons who are to share the content.

### CROSS-REFERENCE TO RELATED APPLICATION

This application claims the benefit of Korean Application No. 2007-19223, filed in the Korean Intellectual Property Office on Feb. 26, 2007, the disclosure of which is incorporated herein by reference.

### BACKGROUND OF THE INVENTION

1. Field of the Invention

Aspects of the present invention relate to an apparatus and method for implementing a user interface used for a group communication and, more particularly, to an apparatus and method for implementing a user interface used for a group communication, which are capable of providing an interface environment in which content, a function that corresponds to the content, and persons who are to share the content can be selected and displayed within the same image, thereby presenting the correlation between and the content and the persons who are to share the content.

2. Description of the Related Art

Mobile communication terminals, such as personal digital assistants (PDAs), personal communication systems (PCSs), and mobile phones, are now widely used. In a communication environment using these mobile communication terminals, communication media, such as speech messages or text messages, have been replaced with photos, music, or moving images. Group communication, such as one-to-many (group) or many-to-many communication, has been actively used.

FIG. 1 illustrates conventional screen images through which a sender transmits mail having an attached photo to a plurality of recipients using MultiMail. A sender first selects photo content 2 from a photo album 1 in a mobile communication terminal and attaches the photo content 2 to mail that is to be transmitted to a plurality of recipients using MultiMail in operation S12. In operation S14, the sender selects a MultiMail attachment function 4 by clicking a menu 3. In operation S16, a screen image 10 is provided. The screen image 10 is used to prepare mail having photo content 2 attached thereto using MultiMail. The sender directly inputs phone numbers of persons (recipients) who are supposed to receive the mail having the attached photo content 2, or selects the recipients' phone numbers from a list including pre-stored phone numbers, and then transmits the mail to the recipients, in operation S18.

Conventionally, a screen image for selecting content, a screen image for selecting a function for processing the content, and a screen image for selecting persons (recipients) who are to share the content are not provided simultaneously, that is, they are provided sequentially or individually.

In addition, it is difficult to know the correlation between the content and persons who are to share the content before the persons are selected.

### SUMMARY OF THE INVENTION

Aspects of the present invention provide an apparatus and method for implementing a user interface used for a group communication, which are capable of providing an efficient interface environment in which content, a function corresponding to the content, and persons who are to share the content can be selected and displayed within the same image, thereby presenting the correlation between the content and the persons who are to share the content.

According to an aspect of the present invention, an apparatus to implement a user interface (UI) used for group communication is provided. The apparatus includes a constructing unit to construct a plurality of UIs in a predetermined format, and an output unit to display the UIs and objects selected by the UIs within a first image, wherein the UIs include at least one of a first UI to select content, a second UI to select a function corresponding to the content, and a third UI to select persons who are to share the content and are arranged to be displayed simultaneously in the first image.

According to another aspect of the present invention, a method of implementing a user interface (UI) used for a group communication is provided. The method includes constructing a plurality of UIs in a predetermined format; and displaying the UIs and objects selected by the UIs within a first image; wherein the UIs comprise at least one of a first UI to select content, a second UI to select a function corresponding to the content, and a third UI to select persons who are to share the content and are arranged to be displayed simultaneously in the first image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates conventional screen images used by a sender to prepare and transmit mail having an attached photo to a plurality of recipients using MultiMail;

FIG. 2 is a block diagram of an apparatus for implementing a user interface used for a group communication, according to an embodiment of the present invention;

FIG. 3 illustrates a user interface image according to an embodiment of the present invention;

FIGS. 4 and 5 illustrate a technique of selecting content, a function corresponding to the content, and persons who are to share the content, according to an embodiment of the present invention;

FIG. 6 illustrates a user interface image according to another embodiment of the present invention;

FIGS. 7 and 8 illustrate a technique of selecting content, a function corresponding to the content, and persons who are to share the content, according to another embodiment of the present invention; and

FIG. 9 is a flowchart illustrating a technique of selecting content, a function corresponding to the content, and persons who are to share the content, according to an embodiment of the present invention.

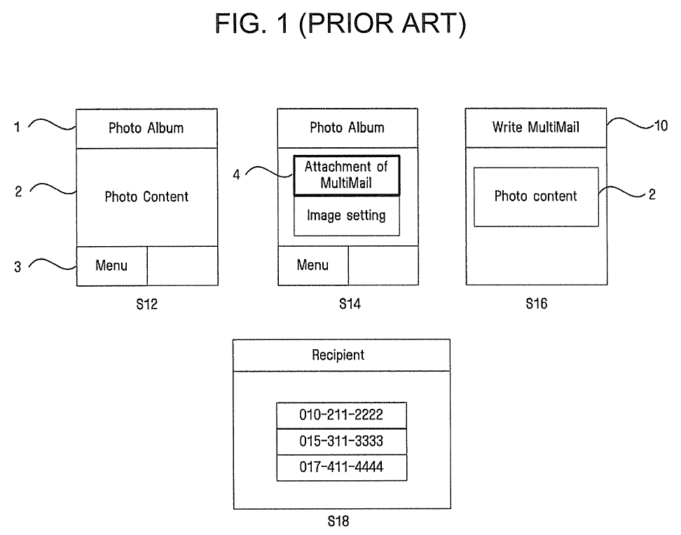

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

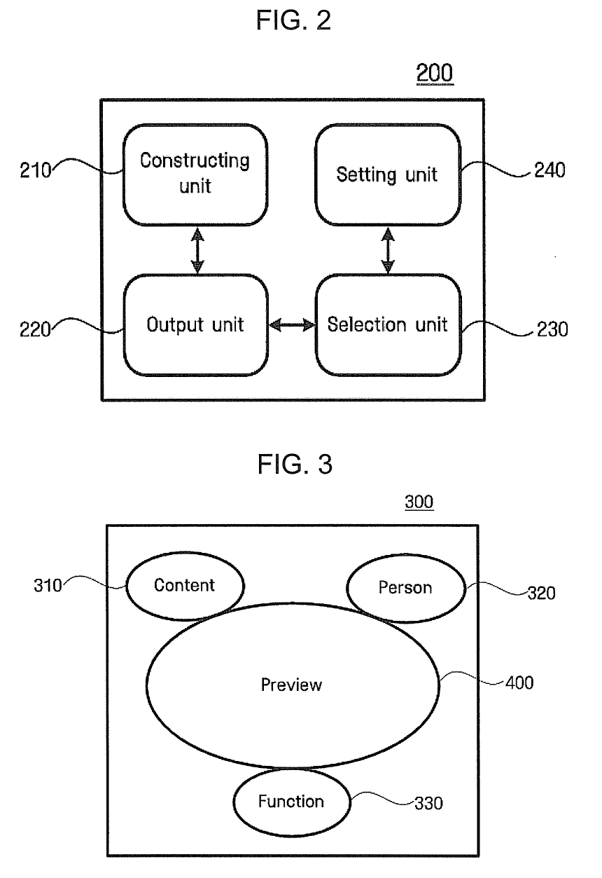

FIG. 2 is a block diagram of an apparatus 200 for implementing a user interface (UI) used for a group communication, according to an embodiment of the present invention. The apparatus 200 may be embodied as a mobile communication terminal, such as a personal digital assistant (PDA), a personal communication system (PCS), personal entertainment device, a camera, or a mobile phone. However, aspects of the present invention are not limited to the apparatus 200 and may be applied to any apparatus having a display device installed or connected thereto, such as a portable or non-portable computer. The apparatus 200 includes a constructing unit 210, an output unit 220, a selection unit 230, and a setting unit 240. While not shown, the apparatus can send data through an interface to other users using wireless and/or wired protocols so as to share the content selected according to aspects of the present invention.

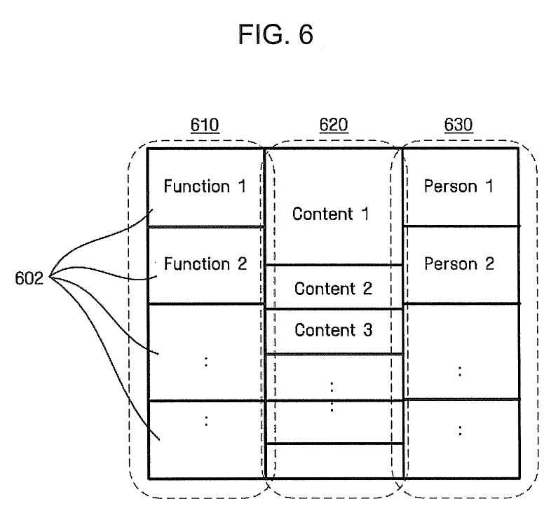

The constructing unit 210 constructs a plurality of UIs in a predetermined format. The UIs may include at least one of a first UI for selecting content, a second UI for selecting a function corresponding to the content, and a third UI for selecting persons who are to share the content (“content sharing persons”). The UIs may be constructed as illustrated in FIG. 3 or FIG. 6, which will later be described, or may be constructed in various other ways. The constructing unit 210 can construct lists according to the format of a UI. The lists include menus for selecting content, functions that are to correspond to the content, and persons who are to share the content. See FIG. 3 through FIG. 8 for more details. As used herein, “at least one of” refers to any combination of one or more items. Thus, for example, the UIs may be any combination of one or more of the UI for selecting content, the UI for selecting a function corresponding to the content, or the UI for selecting persons who are to share the content. However, other aspects of the invention may utilize different UIs and/or additional UIs.

The output unit 220 displays the UIs and objects selected by the UIs in a first image. In this case, the objects may be content, a function corresponding to the content, or a person who is to share the content. Objects may refer to other items as well, such as items related to the content, such as music or software/animation.

The constructing unit 210 arranges the UIs in units of blocks as illustrated in FIG. 6, which will later be described in detail, and displays the UIs in the first image via the output unit 220. While not required in all aspects, when one of the UIs is selected, a block having the selected UI may be enlarged and blocks having the other UIs may be reduced to save screen space. Each of the blocks may be divided into a plurality of regions, and each of the regions may include one of the lists constructed according to the format of UI. Content, a function corresponding to the content, and persons who are to share the content, which are selected from the lists, may be respectively displayed in the blocks in which the UIs are present. In particular, the persons who are to share the content may be displayed in the blocks as text, as numbers, and/or as thumbnail images. As used herein, “blocks” is to be interpreted broadly, and may include figures of any shape and/or size.

If one of the UIs is selected, the output unit 220 may display the lists constructed according to the selected UI in a second image included in the first image as illustrated in FIG. 3, which will later be described in detail. Content and persons who are to share the content, which are selected from the lists, may be arranged by the constructing unit 210 so as not to overlap one other, and may be displayed via the output unit 220. However, the arrangement is not limited thereto.

The output unit 220 may include an image display device, such as a cathode ray tube (CRT), a liquid crystal display (LCD), a light-emitting diode (LED), an organic light-emitting diode (OLED), or a plasma display panel (PDP), or may output data to a display device included in the apparatus 200 or connected to the apparatus 200.

The selection unit 230 is used to select content, a function corresponding to the content, and persons who are to share the content, according to the format of UI. The selection unit 230 may be embodied as a mouse, a keyboard, a keypad, a touchscreen, a touchpad, a microphone, a clickwheel, or other device capable of receiving user input. For example, the user can select desired content, a function corresponding to the content, and persons who are to share the content while moving the UIs displayed on a screen of a mobile communication terminal using a keypad of the mobile communication terminal.

The setting unit 240 sets the constructing unit 210 to construct the plurality of UIs in the format illustrated in FIG. 3 or FIG. 6. The user may select one of the formats illustrated in FIGS. 3 and 6 via the setting unit 240. Thus, a particular user interface may be conveniently selected at the user's option. The constructing unit 210 may, according to other aspects of the invention, construct the UIs including the first through third UIs in various formats other than the format illustrated in FIGS. 3 or 6. For example, the UIs may be arranged vertically or in concentric circles

The term ‘unit’, as used in FIG. 2, refers to, but is not limited to, a software or hardware component that performs certain tasks, such as a Field Programmable Gate Array (FPGA) or Application Specific Integrated Circuit (ASIC). A unit may be advantageously configured to reside on the addressable storage medium and to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, the components and units may be implemented such that they execute on one or more computers in a communication system.

FIG. 3 illustrates a user interface image according to an embodiment of the present invention. UIs for selecting content, a function corresponding to the content, and persons who are to share the content, are displayed in one main image 300 in a mobile communication terminal. The user (sender) may select content that is to be shared from a content UI 310. The user may select persons who are to share the content from a person UI 320, and may select a function corresponding to the content from a function UI 330.

When the user selects one of the UIs (for example, by clicking on one of the UIs), the lists constructed by the selected UI are displayed in a preview image 400 in the main image 300. Content, a function corresponding to the content, and persons that are to share the content, which are selected in the preview image 400, may be displayed in the main image 300 as being related to one another so that a user can view the various items.

For example, the user is able to instinctively detect persons who are to share music from the main image 300 while listening to music. As described above, a UI image for displaying the correlation among content, a function corresponding to the content, and persons who are to share the content, can be constructed in various ways, such as the ways illustrated in FIGS. 3 and 6.

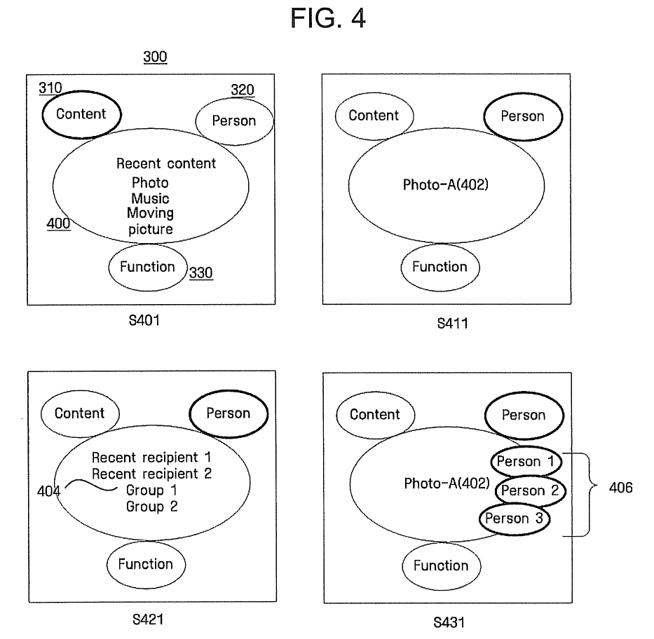

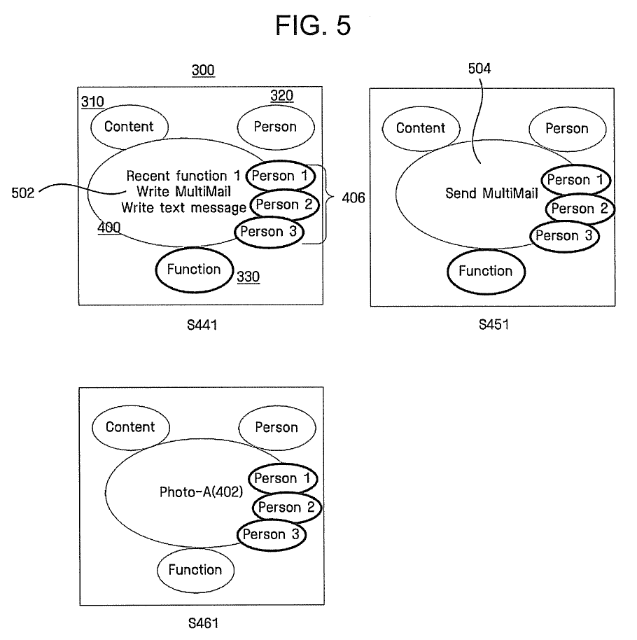

A technique of displaying the correlation among content, a function corresponding to the content, and persons who are to share the content by using the main image 300 of FIG. 3, will now be described in greater detail with reference to FIGS. 4 and 5. FIGS. 4 and 5 illustrate a technique of selecting content, a function corresponding to the content, and persons who are to share the content, according to an embodiment of the present invention.

The content UI 310, the function UI 330, and the person UI 320 may be sequentially selected. Elements belonging to the content UI 310, the function UI 330, and the person UI 320 may then be selected. However, the user may select the UIs in various other sequences at user's option. For example, the user may sequentially select the function UI 330, the person UI 320, and the content UI 310, or sequentially select the content UI 310, the persons UI 320, and the function UI 330.

Referring to FIG. 4, the user may desire to include content (e.g., a photo-A 402,) in a message and send the message to a plurality of persons using MultiMail. That is, the user may desire to share the photo-A 402 with a plurality of persons using MultiMail. First, the user clicks on the content UI 310 in the main image 300 in order to select the photo-A 402 (photo content). Then, lists constructed based on the content UI 310, e.g., menus of recent content, photos, music, and moving pictures, are displayed in a preview image 400 included in the main image 300 in operation S401.

Since the photo-A 402 is photo content, the user clicks on the photo menu, and detects and selects the photo-A 402 from the displayed photo content. The photo-A 402 is displayed in the preview image 400 so that the user can recognize that the photo-A 402 has been selected in operation S411.

Once the photo content has been selected, focus on the content UI 310 may be automatically moved onto the person UI 320 or the function UI 330. For example, the focus may move onto the person UI 320. However, the focus need not be automatically changed, such as where additional content is to be selected or where the focus is manually changed.

The user clicks on the person UI 320 in order to select persons who are to share the photo-A 402. Lists belonging to the person UI 320, such as menus of Recent recipient 1, Recent recipient 2, Group 1, and Group 2, are displayed in the preview image 400 in step S421. Each of the Recent recipient 1 and the Recent recipient 2 may be a recipient list in which recent users and messages, and the phone numbers and names of recipients who have established communications via other media, are registered. The Group 1 and Group 2 may be lists of the names and phone numbers of recipients whom the user has registered. The members of the various groups may be determined in other ways, such as by common interest or common features. Moreover, groups of people need not be selected and instead groups can be formed from individuals.

For example, if the photo-A 402 is to be shared with the “Group 1” 404, the user selects persons 406 (that is, Person 1, Person 2, and Person 3.) The selected persons 406 are displayed around the preview image 400 so as not to overlap the photo-A 402. As a result, in operation S431 the user can check all the selected photo-A 402 and persons 406. If one of persons 406 should not receive the content, the user can thus remove the person and/or add another person.

Next, as illustrated in FIG. 5, the user clicks on the function UI 330 so as to select a function corresponding to the photo-A 402. In operation S441, lists belonging to the function UI 330, that is, menus of Recent function 1, Write MultiMail, and Write text message, are displayed in the preview image 400. The Recent function 1 includes a function that the user has recently clicked on in order to select corresponding content, and the MultiMail writing function provides a function of writing mail messages using MultiMail. The message writing function simply provides writing a text message. Various other functions may be added, such as writing e-mail, writing a schedule, sharing a file or a document, etc.

If the user selects a MultiMail writing function 502, the photo-A 402 is attached to the mail and the mail having the attached photo-A 402 is transmitted to the persons 406 using MultiMail. A message 504 indicating that the mail has been transmitted using MultiMail is displayed in the preview image 400 in step S451. The photo-A 402 and the persons 406 are displayed in the main image 300 so as to allow the user to select a function that is to further correspond to the photo-A 402 from the function UI 330 in step S461. While described in terms of MultiMail, it is understood that other email programs may be used.

The UIs indicated by circles shown in FIGS. 4 and 5, locations of the UIs, and the lists constructed according to each of the UIs, are not limited thereto and may be changed in various ways. The UIs may be located in any area of the screen (for example, the position of the content UI 310 and the person UI 320 may be switched) or may be displayed in any shape.

FIG. 6 illustrates a user interface image according to another embodiment of the present invention. As illustrated in FIG. 6, UIs for selecting a plurality of pieces of content, functions that are to correspond to the content, and persons who are to share the content may be arranged on a screen in units of blocks. The UIs are divided into three blocks (a first block 610, a second block 620, and a third block 630) in the vertical direction; however, the UIs may be displayed horizontally or in a different number of blocks. For example, four UIs may be displayed using four blocks.

Each of the blocks is divided into a plurality of regions 602, and each of the regions 602 may include one of the lists constructed according to the format of UI. In the case of the content UI 310, each of the regions 602 may include a list of content. In the case of the person UI 320, each of the regions 602 may include a list of content sharing persons. In the case of the function UI 330, each of the regions 602 may include a list of functions that are to correspond to content.

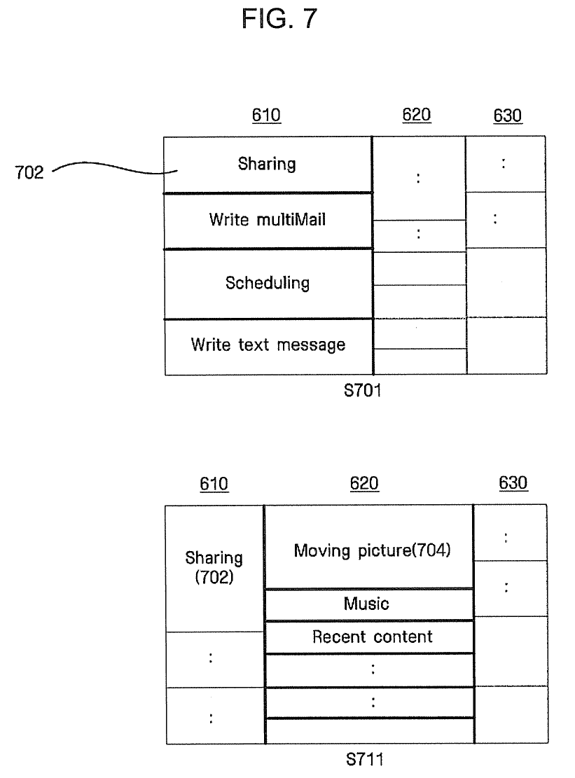

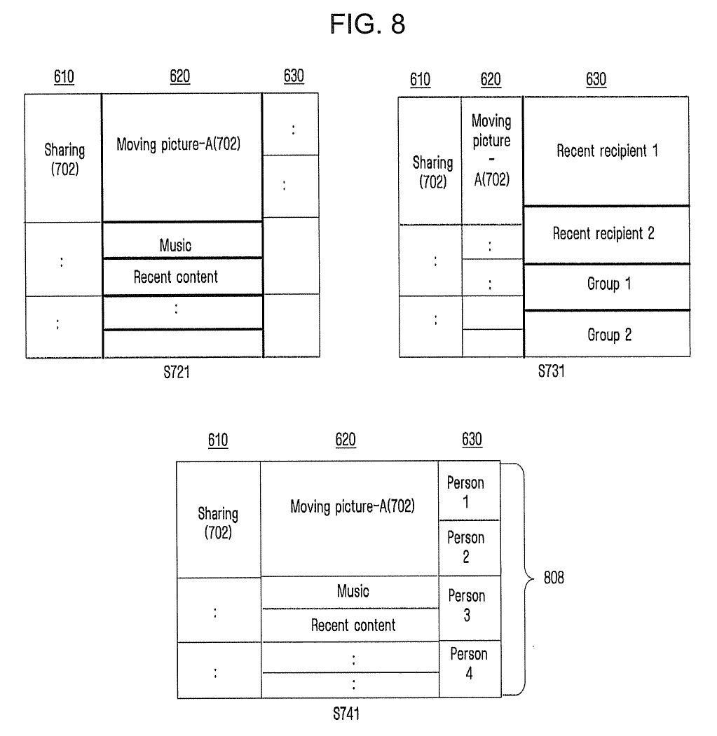

The first block 610 acts as a function UI for selecting functions that are to correspond to content, the second block 620 acts as a content UI for selecting content, and the third block 630 acts as a person UI for selecting persons who are to share content. Of course, the blocks may be selected in a different sequence at the user's option. For example, the user may first select content from the second block 620 and select a function that is to correspond to the content from the first block 610, or first select persons who are to share content from the third block 630 and select content from the second block 620, which will be described in greater detail with reference to FIGS. 7 and 8.

FIGS. 7 and 8 illustrate a process of selecting content, a function corresponding to the content, and persons who are to share the content, according to another embodiment of the present invention. For example, the user may desire to share a moving picture-A 702 (content) with a plurality of persons. In this case, the first block 610 may act as the function UI 330, the second block 620 may act as the content UI 310, and the third block 630 may act as the person UI 320. Such sharing may be by a peer-to-peer technology or utilize servers to send files, but need not be limited thereto.

In operation S701, the user moves a focus onto the first block 610 so as to select a sharing function 702. In this case, the selected first block 610 may be displayed to be enlarged on a screen as shown, and the other blocks may be displayed to be reduced on the screen. For example, the selected first block 610 may be enlarged from top to bottom or from side to side, and the details included in the reduced blocks may contract or disappear. The sharing function 702 (the function selected by the user) may be displayed to be larger than the other elements belonging to the list in the first block 610. However, the block 610 can be otherwise changed to indicate a selected function, such as by changing a color and/or through an emitted sound.

In operation S711, the focus is moved onto the second block 620 via arrow keys (or other input device) so as to select a moving picture menu 704. Moving content included in the selected moving picture menu 704 are displayed in the second block 620 so that the user can view the moving content. The user selects the moving picture-A 702 from the displayed moving content.

Referring to FIG. 8, in operation S721, the moving picture-A 702 selected from the second block 620 may be displayed to be larger than the other elements as shown, but need not be so changed in all aspects. The focus is moved onto the third block 630 via the arrow keys in operation S731 so as to select persons who are to share the moving picture-A 702.

The sharing function 702, the moving picture-A 702 corresponding to the function of sharing 702, and persons 808 who are to share the moving picture-A 702 are displayed on the screen in operation S741. The persons 808 may be arranged as text or thumbnails. The user may click on a predetermined button so as to share the moving picture-A 702 with the persons 808.

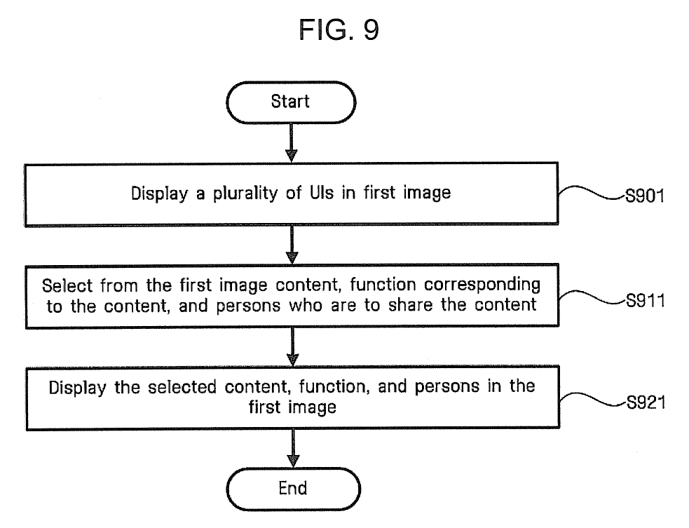

FIG. 9 is a flowchart illustrating a technique of selecting content, a function corresponding to the content, and persons who are to share the content, according to an embodiment of the present invention. A plurality of UIs are displayed in a first image in a predetermined format in step S901. The predetermined format may be as illustrated in FIG. 3 or FIG. 6, or may be another format.

In operation S911, the user selects content, a function corresponding to the content, and persons who are to share the content from lists constructed according to the format of the UI displayed in the first image. The selected content, function, and persons are displayed in the first image via the output unit 220 in operation S921. The selected content and persons may be arranged so as not to overlap one another and then displayed in the first image. The user may perform the function corresponding to the content. For example, the user may attach the selected content to mail and transmit the mail to the content sharing persons, such as using MultiMail. However, it is understood that the selected contents can partially overlap in aspects of the invention to more efficiently use limited screen space.

The above apparatus and method for implementing a user interface used for a group communication, according to aspects of the present invention, has several advantages. First, the user can select and check content, a function corresponding to the content, and persons who are to share the content within the same image, without needing to move to another user interface. Second, the user can instinctively grasp a relationship between the content and the persons who are to share the content.

User interfaces and user interface display techniques according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to implement a user interface (UI) used for group communication, the apparatus comprising:
a constructing unit to construct a plurality of UIs in a predetermined format; and
an output unit to display the UIs and objects selected by the UIs within a first image,
wherein the UIs comprise at least one of a first UI to select content, a second UI to select a function corresponding to the content, and a third UI to select persons who are to share the content and are arranged to be displayed simultaneously in the first image.

2. The apparatus of claim 1, wherein the UIs are displayed in the first image as a plurality of blocks.

3. The apparatus of claim 2, wherein, when one of the first through third UIs is selected, a block having the selected UI is enlarged and blocks having the other UIs are reduced.

4. The apparatus of claim 2, wherein each of the blocks is divided into a plurality of regions, and each of the regions comprises lists constructed according to the predetermined format of the UIs.

5. The apparatus of claim 4, wherein the content, the function corresponding to the content, and the persons who are to share the content, which are selected from the lists constructed according to the predetermined format of the UIs, are respectively displayed in the blocks in which the UIs are present.

6. The apparatus of claim 5, wherein the persons who are to share the content are displayed as thumbnails.

7. The apparatus of claim 1, wherein, when one of the first through third UIs is selected, lists constructed according to the selected UI are displayed in a second image included in the first image.

8. The apparatus of claim 7, wherein content and persons who are to share the content, which are selected from the lists constructed according to the format of UI, are arranged so as not to overlap one another, and are displayed in at least one of the first and second images.

9. A method of implementing a user interface (UI) used for a group communication, the method comprising:
constructing a plurality of UIs in a predetermined format; and
displaying the UIs and objects selected via the UIs within a first image;
wherein the UIs comprise a first UI to select content, a second UI to select a function corresponding to the content; and a third UI to select persons who are to share the content and are arranged to be displayed simultaneously in the first image.

10. The method of claim 9, wherein the displaying of the UIs comprises displaying the UIs in the first image as a plurality of blocks.

11. The method of claim 10, further comprising enlarging a block having a selected UI and reducing the blocks having the other UIs when one of the first through third UIs is selected.

12. The method of claim 10, wherein each of the blocks is divided into a plurality of regions, and each of the regions comprises lists constructed according to a format of one of the UIs.

13. The method of claim 12, wherein the displaying of the UIs comprises displaying content, a function corresponding to the content, and persons who are to share the content, which are selected from the lists constructed according to the format of one of the UIs, in the blocks in which the UIs are present.

14. The method of claim 13, wherein the displaying of the UIs comprises displaying the persons who are to share the content are displayed as thumbnails.

15. The method of claim 9, further comprising displaying lists constructed according to the selected UI in a second image included in the first image when one of the first through third UIs is selected.

16. The method of claim 15, further comprising:
displaying the content and the persons who are to share the content, which are selected from the lists constructed according to the format of UI, in at least one of the first and second images;
wherein the content and the persons who are to share the content are arranged so as not to overlap one another.

17. An apparatus comprising:
an output unit to display a plurality of user interfaces (UIs) simultaneously within a single image;
a constructing unit to construct the plurality of UIs within the single image to be displayed by the output unit;
a selection unit to receive input from a user and to select objects displayed within the plurality of UIs; and
a setting unit to control the constructing unit to construct the plurality of UIs according to a format selected by the user.

18. The apparatus of claim 17, wherein:
the constructing unit constructs a list of objects for each UI based on a format of each UI.

19. The apparatus of claim 18, wherein:
the image is composed of a plurality of blocks that are at least partially not overlapping; and
each of the plurality of UIs is displayed in a corresponding one of the plurality of blocks so as to allow the simultaneous display of the UIs in the non-overlapping portions.

20. The apparatus of claim 19, wherein the apparatus is a mobile apparatus.

21. The apparatus of claim 17, wherein one of the UIs is a function UI to allow the user to select a function relating to content.

22. The apparatus of claim 17, wherein one of the UIs is a content UI to allow the user to select content.

23. The apparatus of claim 17, wherein one of the UIs is a person UI to allow the user to select persons, or groups of persons, who are to share content.

24. The method of claim 9, wherein the displaying of objects selected via the UIs comprises displaying a preview of content selected via the first UI.
